(19) United States
(12) Patent Application Publication
(10) Pub. No.: US 2001/0016923 A1
(43) Pub. Date: Aug. 23, 2001

(54) Program execution system for semiconductor testing apparatus

(76) Inventor: Yasuyoshi Yamashita, Tokyo (JP)

Correspondence Address: DELLETT AND WALTERS, 310 S.W. FOURTH AVENUE, SUITE 1101, PORTLAND, OR, 97204, US

(21) Appl. No.: 09/757,324

(22) Filed: Jan. 9, 2001

(30) Foreign Application Priority Data
Jan. 11, 2000 (JP) 2000-006080

(51) Int. Cl. G06F 11/263

(52) U.S. Cl. 714/31

(57) ABSTRACT

Program execution system for semiconductor testing apparatus is disclosed. In this system, a device test program includes first statements written in a universal programming language and second statements written in a non-universal programming language that is dependent on the semiconductor testing apparatus, each statement being executed at a separate program executing part.

### BACKGROUND OF THE INVENTION

This invention relates to a program execution system for semiconductor testing apparatus performing various operation tests on a semiconductor device such as a semiconductor memory.

Conventionally, semiconductor testing apparatus which perform predetermined operation tests on various semiconductor devices are known. For example, the semiconductor devices as DUT (device under test) include a semiconductor memory, a logic IC, a linear IC, etc., and suitable semiconductor testing apparatus are used for respective semiconductor devices. These various semiconductor testing apparatus are designed to perform predetermined functional tests, direct current tests (DC parametric tests), etc. by executing predetermined device test programs programmed by users. The device test program is constituted broadly by three parts— tester control statements, data processing statements, and algorithm statements. The tester control statements include various instructions for controlling hardware of the semiconductor testing apparatus, for example instructions for setting testing conditions and instructions for executing the tests. The data processing statements have no direct relation to the hardware of the semiconductor testing apparatus and include instructions for processing data resulting from the semiconductor tests. The algorithm statements include instructions for directing how to run the entire device test programs.

The above mentioned conventional device test programs have been written in unique programming languages developed by manufacturers of the semiconductor testing apparatus. In such a device test program, an object as an intermediate language is generated by compilation and executed. However, since the statements of the object are interpreted line by line in this execution, there has been a problem that the execution speed is low compared with the cases in which universal programming languages such as C language are used.

Further, for programmers of device test programs, there has been a problem that their familiarity with their programming task does not serve for purposes other than programming of their device test programs, so that it does not lead to mastery of programming skill in universal programming languages.

There has also been a problem that, since the algorithm statements of the device test program are written in a non-universal unique programming language, it is not easy to rewrite the program in a universal programming language such as C language, resulting in poor portability to universal programming languages.

Further, since programming languages for limited purposes are generally used in device test programs, available functionality is often limited compared with the cases in which universal programming languages such as C language are used. For example, an approach of structured programming cannot be used if structures and unions are not provided.

### SUMMARY OF THE INVENTION

The present invention was created in view of these situations, and it is an object of the present invention to provide a program execution system for semiconductor testing apparatus which can increase execution speed, helps to master a universal programming language, and can improve portability of the program.

In the program execution system for semiconductor testing apparatus of the present invention, a device test program includes first statements which are dependent on the semiconductor testing apparatus and written in a non-universal programming language, and second statements which are independent of the semiconductor testing apparatus and written in a universal programming language. The system performs various tests on a semiconductor device with the semiconductor testing apparatus, by executing the above mentioned first statements with first program executing unit and by executing the above mentioned second statements with second program executing unit. Since the second statements, which are a part of the device test program and independent of the semiconductor testing apparatus, can be written in a universal programming language, it is easy to rewrite the device test program in the universal programming language, so portability of the program can be improved. Further, one can master programming skill in the universal programming language by getting familiar with programming etc. of the device test program, and this allows him to acquire versatile knowledge and to improve his skill. The execution speed of the entire device test program can also be increased, since execution of statements written in a universal programming language such as C language is generally faster than execution of statements written in a programming language which is dependent on and unique to a semiconductor testing apparatus.

Further, it is desirable that the above mentioned first statements include instructions for controlling the operation of the semiconductor testing apparatus, and the second statements include instructions for processing data resulting from execution of the first statements and instructions for defining execution procedures of the entire device test program. Since writing the instructions for controlling the operation of the semiconductor testing apparatus in a universal programming language would result in a wasteful and redundant description content, writing the instructions in a non-universal programming language can make the content of the device test program simple and easy to understand. Further, since any programming language can be used to describe the parts for description of algorithms indicating other execution procedures and for description of contents of data processing, it is possible to improve portability of the program and to acquire versatile knowledge, as described above by writing the parts in a universal programming language.

It is also desirable that the above mentioned semiconductor testing apparatus comprises test executing unit for generating various testing signals for the semiconductor device and for acquiring output signals which are outputted from the semiconductor device in response to the testing signals, and that the semiconductor testing apparatus executes input/output operation of the testing signals and output signals by the test executing unit when it executes the first statements by the first program executing unit. Performing various tests on the semiconductor device requires to input/output various signals between the semiconductor testing apparatus and the semiconductor device as a DUT, and moreover, such input/output operation is possible by causing the test executing unit, which is specific to the semiconductor testing apparatus, to conduct special operation. Therefore, by using the first statements including the unique instructions in a non-universal programming language for such special operation to occur, an efficient device test program can be programmed.

It is also desirable that the above mentioned semiconductor testing apparatus has a tester processor which interprets and executes a first program composed of the first statements with a predetermined emulator while directly executing a second program composed of the second statements. Generally, processing speed in directly executing the first program written in a universal programming language is faster than that in executing the first program written in a non-universal programming language while interpreting it with a predetermined emulator. Thus, execution speed can be faster compared with the case of using conventional device test programs, which are entirely written in non-universal unique programming languages.

It is also desirable that the above mentioned universal programming language is C language. The second statements written in C language can be immediately translated to those in an assembler language when compiled, so execution speed can be faster, because no intermediate language is used, that is, no processing such as interpretation of the intermediate language is required when executing the device test program (object program) corresponding to the second statements.

### BRIEF DESCRIPTION OF THE DRAWINGS

FIG. 1 shows a whole configuration of the semiconductor testing apparatus according to an embodiment.

FIG. 2 is a diagram showing an example of the device test program.

### DESCRIPTION OF THE PREFERRED EMBODIMENT

Now, a semiconductor testing apparatus of an embodiment to which this invention is applied will be described with reference to the drawings.

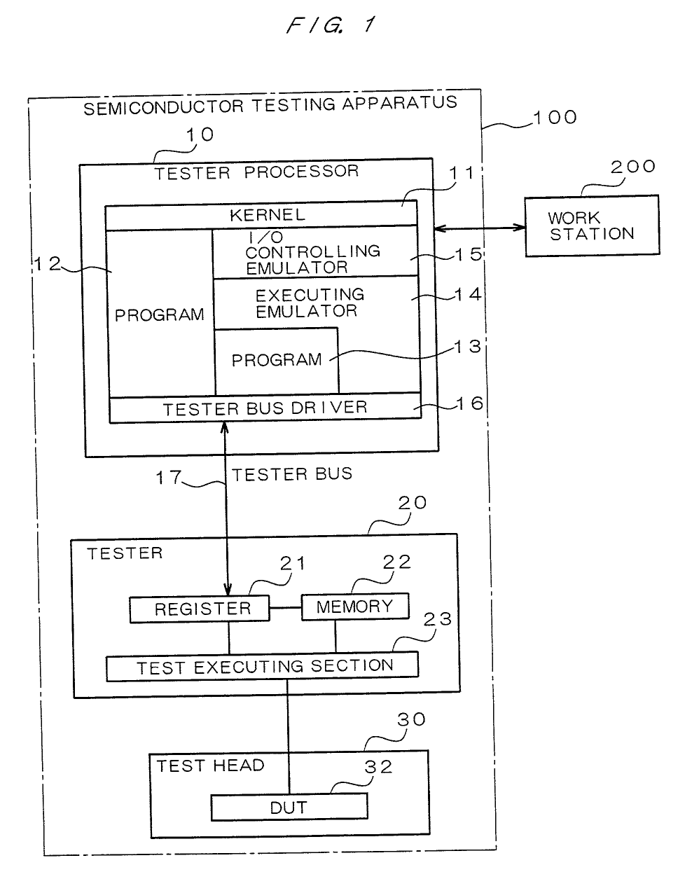

FIG. 1 shows the whole configuration of the semiconductor testing apparatus of this embodiment. The semiconductor testing apparatus 100 shown in this figure comprises a tester processor 10, a tester 20, and a test head 30. This semiconductor testing apparatus 100 is configured to be able to perform predetermined tests on a DUT 32, which is a semiconductor device to be tested, using the test head 30.

The tester processor 10 is designed to control operation of the tester 20 and comprises a kernel 11, programs 12 and 13, an executing emulator 14, an I/O controlling emulator 15, and a tester bus driver 16. One of the programs, the program 12, is written in C language, which is a universal programming language. The other program, the program 13, is written in a non-universal unique programming language, which is developed for these semiconductor tests. The two programs 12 and 13 constitute a device test program that defines procedures and details for performing various tests such as functional tests or DC parametric tests on the DUT 32.

The kernel 11 is a realtime operating system which has functions to execute the program 12, the executing emulator 14, and the I/O controlling emulator 15 respectively.

The device test program includes three functional parts, (1) a tester controlling part, (2) a data processing part, and (3) an algorithm describing part. Among these parts, the tester controlling part (1) consists of statements which include instructions for controlling hardware of the semiconductor testing apparatus 100. The data processing part (2) has no direct relation to the hardware of the semiconductor testing apparatus 100, and consists of statements which include instructions for processing various data acquired as test results. The algorithm description part (3) consists of statements which include instructions for indicating how to execute the entire device test program.

One of the programs, the program 12, written in C language, corresponds to the data processing part and the algorithm describing part among the three functional parts included in the device test program. The kernel 11 directly executes this program 12 to control various kinds of data processing and execution procedures included in each statement.

The other program, the program 13, written in a non-universal programming language, corresponds to the tester controlling part among the three functional parts included in the device test program.

The executing emulator 14 is designed to execute the program 13 and interprets and executes a plurality of lines of the statements included in the program 13 line by line. For example, the program 13 is an object in an intermediate language resulting from the compilation of a source program, and each statement of the object is interpreted and executed by the executing emulator 14.

The I/O controlling emulator 15 interprets and executes input/output instructions for controlling input/output operation of data etc. between the executing emulator 14 and a workstation 200. The instructions in the program 13 also include input/output instructions required for performing disk access, key input, or displaying for the workstation 200, and the execution of these input/output instructions by the I/O controlling emulator 15 gives operational directions to the workstation 200. The tester bus driver 16 is designed to send/receive various data via a tester bus 17 and controls sending of various data required for the functional tests or DC parametric tests to the tester 20 or receiving of test results which are outputted from the tester 20.

The tester 20 is designed to perform various tests such as functional tests, DC parametric tests, or RF tests (radio frequency tests) for the DUT 32 mounted on the test head 30, under control of the tester processor 10. This tester 20 comprises a register 21, a memory 22, and a test executing section 23. The register 21 stores various data sent to/received from the tester bus driver 16 of the tester processor 10. Data stored in the register 21 is sent directly or via the memory 22 to the test executing section 23. Data outputted from the test executing section 23 is once stored in the register 21 or the memory 22 and then sent to the tester bus driver 16 within the tester processor 10 via the register 21. The test executing section 23, which includes various arrangements (for example a pattern generator, a timing generator, a DC unit, etc.) required for performing functional tests for the DUT 32, generates various signals which are to be inputted to the DUT 32 while measuring data which appears at the output pins of the DUT 32.

The above described kernel 11 corresponds to second program executing unit, and the kernel 11, the executing emulator 14, and the I/O controlling emulator 15 correspond to first program executing unit, and the test executing section 23 corresponds to test executing unit, respectively.

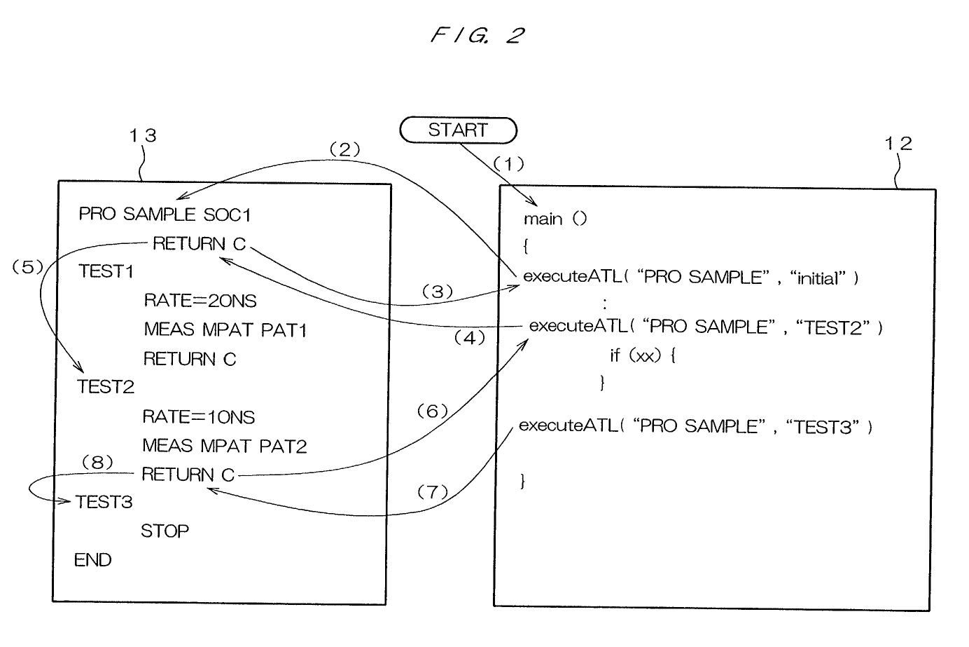

The semiconductor testing apparatus 100 of this embodiment has such a configuration, and now its operation will be described. FIG. 2 shows specific contents of the two programs 12 and 13, which constitute the device test program. Arrows indicate the program flow and parenthesized numbers attached to the arrows shown in FIG. 2 indicate the sequence of the flow. In the following description will be made of the operations performed when executing the respective statements in the order of the parenthesized numbers.

(1) When the device test program is directed to be executed, for example by using a keyboard provided for the workstation 200, the kernel 11 first reads out the program 12 to execute sequentially from its first statement “main( )”. This main function is executed first among various functions of C language included in the program 12 written in C language.

(2) On execution of a statement “executeATL(“PRO SAMPLE”, “initial”)” by the kernel 11, the program 12 calls the program 13, specified by a program name “PRO SAMPLE” to direct initialization process of the program. In response to this direction, the executing emulator 14 executes initialization process of the program 13, specified by the program name “PRO SAMPLE”.

(3) After completion of initialization process, the executing emulator 14 executes a statement “RETURN C” in the program 13, and an execution position returns to the program 12 at a position where it is previously interrupted.

(4),(5) On execution of a statement “executeATL(“PRO SAMPLE”,“TEST2”)” by the kernel 11, the executing emulator 14 executes statements specified by “TEST2” of the program 13. For example, each of the statements “RATE=10NS” and “MEAS MPAT PAT2” is executed. “RATE” is an instruction for setting a basic cycle of data input/output timing. “MEAS MPAT” is an instruction for directing start of measurement for the functional test. Since execution of these instructions involves input operations of predetermined data to the tester 20, control is passed to the tester bus driver 16 to execute these instructions by the tester bus driver 16.

(6) Thereafter, the executing emulator 14 executes a statement “RETURN C” in the program 13, and the execution position returns to the program 12 at a position where it is previously interrupted.

(7),(8) On execution of a statement “executeATL(“PRO SAMPLE”, “TEST3”)” by the kernel 11, the executing emulator 14 executes a statement specified by “TEST3” of the program 13. For example, the executing emulator 14 executes a statement “STOP” to perform a terminating process of the predetermined functional test.

As above, in the semiconductor testing apparatus 100 of this embodiment, the entire device test program is composed of the program 12 written in a C language which is a universal programming language, and the program 13 written in the non-universal programming language developed for the semiconductor tests. Writing in a universal programming language the parts other than those for directing various operations etc. to the tester 20 facilitates to rewrite the device test program in the universal programming language, thus improving portability of the program.

Further, by getting familiar with programming etc. of the device test program, one can master the universal programming language through programming of the program 12 written in the universal programming language included as a part of the program, so he can acquire versatile knowledge and to improve his skill.

Further, since execution of the program 12 written in a universal programming language such as C language is generally faster than execution of the program 13 written in a programming language which is dependent on and unique to hardware, execution speed can be faster than that of conventional device test programs, the whole of which have been written in non-universal unique programming languages.

In addition, writing the program 12 in C language makes it possible to use structures and unions provided for C language to employ an approach of structured programming.

This invention is not intended to be limited to the above described embodiment, but various modifications are possible within the scope of the spirit of this invention. For example, through the program 12 is written in C language in the above embodiment, any universal programming languages other than C language may be used. JAVA (registered trademark), for example may be used to write program 12.

1. A program execution system for semiconductor testing apparatus which performs various tests for a semiconductor device using the semiconductor testing apparatus by executing a device test program, comprising:
first program executing unit for executing first statements which are dependent on said semiconductor testing apparatus, the first statements being included in said device test program and written in a non-universal programming language, and
second program executing unit for executing second statements which are independent of said semiconductor testing apparatus, the second statements being included in said device test program and written in a universal programming language.

2. The program execution system for semiconductor testing apparatus according to claim 1, wherein:
said first statements include instructions for controlling operation of said semiconductor testing apparatus, and
said second statements include instructions for processing data resulting from execution of said first statements and instructions for defining execution procedures of the entire device test program.

3. The program execution system for semiconductor testing apparatus according to claim 1, wherein:
said semiconductor testing apparatus comprises test executing unit for generating various testing signals for said semiconductor device and acquiring output signals which are outputted from said semiconductor device in response to said testing signals, and
input/output operations of said testing signals and said output signals by said test executing unit are executed when said first program executing unit executes said first statements.

4. The program execution system for semiconductor testing apparatus according to claim 1, wherein said semiconductor testing apparatus has a tester processor which interprets and executes a first program constituted by said first statements with a predetermined emulator while directly executing a second program constituted by said second statements.

5. The program execution system for semiconductor testing apparatus according to claim 1, wherein said universal programming language is C language.
